(19) United States
(12) Patent Application Publication
(10) Pub. No.: US 2003/0107755 A1
(43) Pub. Date: Jun. 12, 2003

(54) Printer capable of displaying proceeding state of printing job and method for controlling the same

(75) Inventor: Hong-rok Woo, Bucheon-city (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/161,680

(22) Filed: Jun. 5, 2002

(30) Foreign Application Priority Data
Dec. 12, 2001 (KR) 2001-78483

(51) Int. Cl. B41J 1/00; G06F 15/00

(52) U.S. Cl. 358/1.14; 358/1.1

(57) ABSTRACT

A printer capable of displaying a state of completion of a printing job through LEDs (Light Emitting Diodes). The printer has the LEDs disposed as one line to display the state of completion of the printing job. When printing data is transmitted from a host, a control unit calculates the number of the LEDs according to the state of completion of the transmitted printing data printed on paper, and controls the LEDs to be consecutively turned on according to the calculated number of the LEDs. Accordingly, a user can judge when the printing job is completed based upon the amount of the current print job that remains.

### CROSS-REFERENCE TO RELATED APPLICATIONS

This application claims the benefit of Korean Application No. 2001-78483, filed Dec. 12, 2001, in the Korean Industrial Property Office, the disclosure of which is incorporated herein by reference.

### BACKGROUND OF THE INVENTION

1. Field of the Invention

The present invention relates to a printer capable of displaying a state of completion of a printing job and a method of controlling the same, and more particularly, to a printer capable of displaying a current state of a printing job through LEDs (Light Emitting Diodes) and a method of controlling the same.

2. Description of the Related Art

Generally, a printer is an apparatus for receiving printing data from a host connected therewith through a cable, and printing the printing data on a printing paper. The type of printer varies in accordance with the method of outputting the printing data on the printing paper and the color. For the convenience of a user, various printing functions have been developed.

FIG. 1 is a flow chart describing an operation of displaying the state of the printing job of a document in a conventional printer. When the printing data is transmitted from the host (S 10), the printer creates a bit-map image by processing the image with respect to the transmitted printing data. The printer turns the LEDs on/off in a blinking fashion. The LEDs are disposed at an OPE (operating panel) for displaying the transmitted state of the printing data (S 20). Furthermore, the printer prints the image processed printing data on the printing paper (S 30). After that, when the printing job is completed (S 40), the LEDs are turned off (S 50). The printer blinks the LEDs while the printer is receiving printing data and creating the bit-map image, thus, the user knows whether the printing is still being completed.

However, the conventional printer described above has a disadvantage. Specifically, the user does not know the state of completion of the current printing job. Specifically, since there is a large time difference between completion of transmission at the host and completion of the printing, the user must wait unnecessarily in front of the printer. For example, the output of the printing paper may not be complete even though the user believes that the printing is complete. Moreover, when a single printer is commonly used by many people, a user waiting for someone else's printing job to finish cannot know the exact time of completion of the current printing job, thus he or she must ask about the amount of printing that remains.

### SUMMARY OF THE INVENTION

Accordingly, it is an object of present invention to overcome the above-mentioned problems of the related art.

Accordingly, it is a further object of the present invention to provide a printer capable of displaying the state of completion of a printing job and a method of controlling the same so that a user can easily judge a completion time of the current job and an available time for a next printing job.

Additional objects and advantages of the invention will be set forth in part in the description which follows and, in part, will be obvious from the description, or may be learned by practice of the invention.

The foregoing and other objects of the present invention are achieved by providing a printer, including a host interface to perform an interface of printing data with a host; a plurality of light emitting elements to display a state of completion of a printing job currently performed by on/off operations thereof; a printing unit to print the printing data on a printing medium; and a control unit to control the on/off operations of the plurality of light emitting elements according to the state of completion of the printing job performed by the printing unit regarding the printing data transmitted through the host interface.

The foregoing and other objects of the present invention are also achieved by providing a method of controlling a printer, including receiving printing data of a printing job from a host, printing the received printing data on a printing medium and controlling on/off operations of a plurality of light emitting elements to display a state of completion of the printing job.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a flow chart describing a method for displaying a state of printing in a conventional printer;

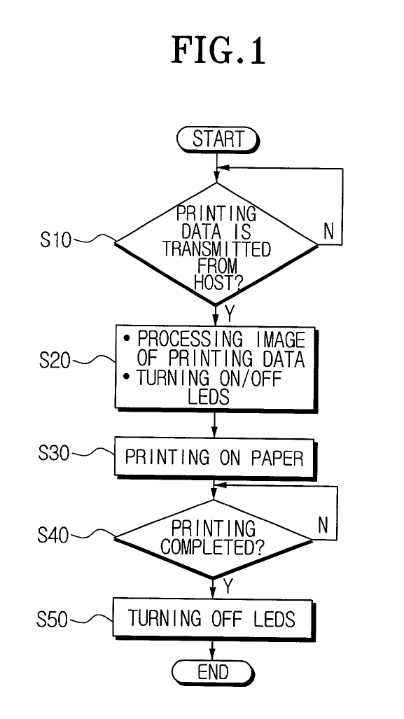

FIG. 2 is a block diagram of a printer having a function of displaying a state of completion of a printing job according to the present invention; and

FIG. 3 is a flow chart describing an operation of the printer of FIG. 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

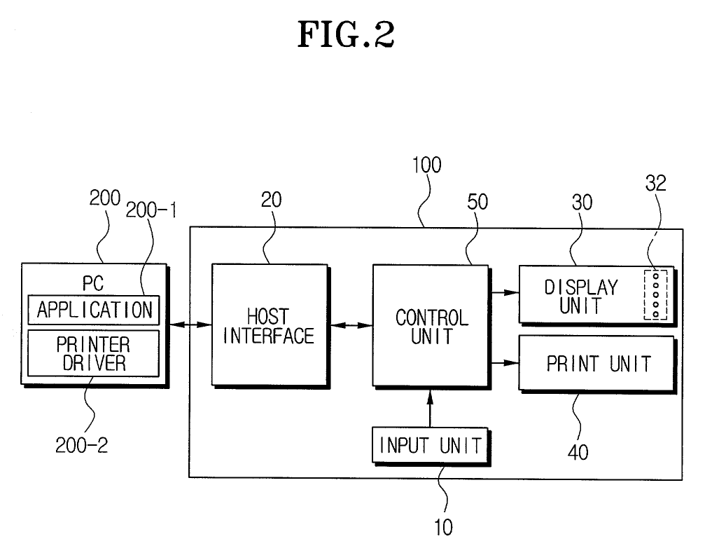

FIG. 2 is a block diagram showing a printer capable of displaying the state of completion of a printing job according to the present invention. The printer 100 includes an input unit 10, a host interface 20, a state of completion display unit 30, a print unit 40, and a control unit 50.

The input unit 10 has a plurality of keys (not shown) to input commands from a user for menu selection and operation of the printer 100. The host interface 20 interfaces printing data with an external device through a cable (not shown). Here, the external device can be a PC 200 having a printer driver 200-2 and an application 200-1 to request printing of a document.

The display unit 30 has a plurality of light emitting elements, for example, LEDs 32. While the LEDs 32 can be arrayed in any arrangement, a single vertical or horizontal line is used as an example so that the user can easily interpret these elements.

The print unit 40 prints the printing data transmitted through the host interface 20 under the control of the control unit 50. The control unit 50 controls the other elements of the printer 100 to process an image of the printing data transmitted through the host interface 20, and to allow the printing data to be printed on the printing paper through the print unit 40. Moreover, the control unit 50 receives from the printer 100 information about a total number of pages of a job which is included in a header of the printing data. Furthermore, the control unit 50 receives information about a page currently being printed, when the printing data is printed on the paper through the print unit 40. Furthermore, based upon the information about the total number of pages and the currently printed page, the control unit 50 controls the on/off operation of each of the LEDs 32 after calculating the number of the LEDs 32 to be turned on with respect to all of the LEDs 32 based upon the received information. Here, the control unit 50 controls the LEDs 32 to be consecutively turned on from a side of the LEDs 32 corresponding to the currently printed page with respect to the total number of pages.

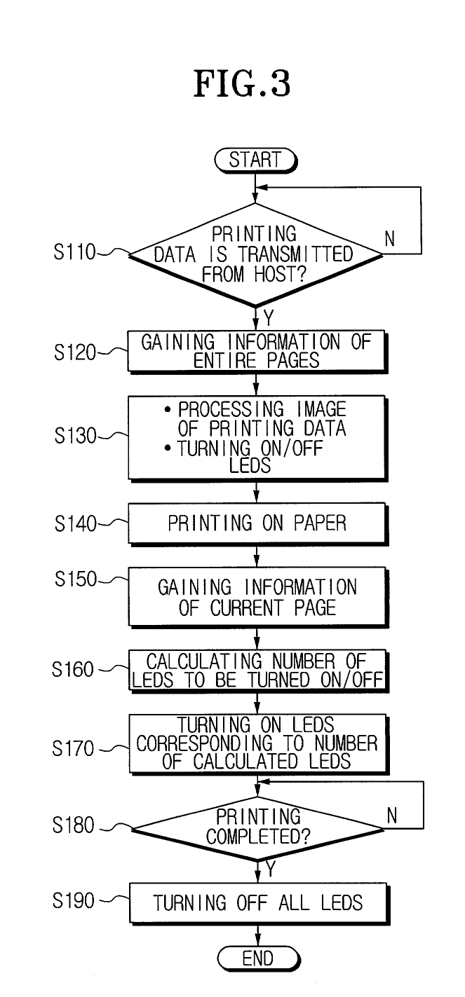

FIG. 3 is a flow chart describing the operation of the printer of FIG. 2.

First, a command to print is selected from the PC 200 through the application 200-1, and the printer driver 200-2 transmits the total page number information in the header of the printing data to the printer 100. After that, the host interface 20 of the printer transmits the printing data to the control unit 50. Then, the control unit 50 judges that the printing data is transmitted from the PC 200 (S 110), and receives the information about the total number of pages from the header information (S 120). Furthermore, the control unit 50 processes the image to perform the printing of the printing data (S 130). At this time, LEDs 32 separately provided can be blinked during the period from the transmission of the printing data to the image processing. After that, the control unit 50 controls the print unit 40 to allow the image processed printing data to be printed on the printing paper (S 140). Moreover, the control unit 50 receives the information about the currently printed page whenever the printing is completed on the printing paper (S 150). Here, the operation S 150 to receive the information about the currently printed page of the printing data can be a start time of the image processing, the completion time of the image processing, or the start time of the printing of the print unit 40. Next, the control unit 50 calculates the number of the LEDs 32 to be turned on through the information about the total number of pages received when receiving the printing data and the information regarding the currently printed page (S 160). The number of the LEDs 32 to be calculated can be expressed as the following mathematical expression 1.

Mathematical Expression 1

$$SCPJ = \frac{{P}_{current}}{{P}_{TOT}}$$

where, SCPJ is a State of Completion of the Printing Job, P_{current} is a currently printed page number and P_{TOT} is an total page number.

Therefore, the number ‘x’ of the LEDs 32 to be turned on can be expressed as the following mathematical expression 2.

Mathematical Expression 2

$$x = \frac{{LED}_{TOt} \times {P}_{current}}{{P}_{TOT}}$$

where, LED_{Tot} is the total number of the LEDs 32.

When the number ‘x’ of the LEDs 32 to be turned on is calculated by the mathematical expression 2, the control unit 50 turns on the LEDs 32 corresponding to the calculated number of the LEDs 32 (S 170). At this time, the LEDs 32 are turned on from a side of the LEDs 32 according to the currently printed page. After the LEDs 32 are consecutively turned on according to the state of completion of the printing job, when the number of the currently printed page is the same as the total number of pages, in other words, the printing is completed (S 180), all of the LEDs 32 are turned off (S 190).

As another method of controlling the printer described above, all of the LEDs 32 can be turned on when the printing data is transmitted, and after that, the LEDs 32 can be consecutively turned off according to the information of the currently printed page with respect to the total number of printing pages.

According to the printer capable of displaying the state of completion of the printing job and the method of controlling the same, the user can easily know the state of completion of the printing job, thus the user does not have to wait in front of the printer. Furthermore, the user does not need to ask about the number of remaining pages in the case when many people use one printer.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A printer, comprising:
a host interface to interface printing data with a host;
a plurality of light emitting elements to display a state of completion of a printing job currently performed by on/off operations thereof;
a printing unit to print the printing data on a printing medium; and
a control unit to control the on/off operations of the plurality of light emitting elements according to the state of completion of the printing job performed by the printing unit regarding the printing data transmitted through the host interface.

2. The printer according to claim 1, wherein the control unit calculates a number of the light emitting elements to be turned on/off according to a currently processed page with respect to a total number of pages of the printing job, and controls the on/off operations of the light emitting elements according to the calculated number of the light emitting elements to be turned on/off.

3. The printer according to claim 2, wherein:
the light emitting elements are arrayed as one line, and
the control unit controls the light emitting elements to be consecutively turned on from a side of the line in accordance with the calculated number of the light emitting elements.

4. The printer according to claim 2, wherein the control unit receives information with respect to the total number of pages of the printing job from a header information of the printing data.

5. A method of controlling a printer, comprising:
receiving printing data of a printing job from a host;
printing the received printing data on a printing medium; and
controlling on/off operations of a plurality of light emitting elements to display a state of completion of the printing job according to the state of completion of the printing job of the printing data printed on the supplied printing paper.

6. The method according to claim 5, wherein the controlling of the on/off operations comprises:
calculating a number of the light emitting elements to be turned on/off with respect to a total number of the light emitting elements according to a currently processed page with respect to a total number of pages of the printing data; and
controlling the on/off operations of the light emitting elements according to the calculated number of the light emitting elements.

7. The method according to claim 6, wherein
the light emitting elements are arrayed as one line, and
the light emitting elements are consecutively turned on/off from a side of the line in accordance with the calculated number of the light emitting elements.

8. The method according to claim 6, further comprising:
receiving information with respect to the total number of pages of the printing data from a header information of the received printing data.
